(19) United States
(12) Patent Application Publication
(10) Pub. No.: US 2004/0008176 A1
(43) Pub. Date: Jan. 15, 2004

(54) Brightness control device and a monitor

(76) Inventor: Yoshimi Nuimura, Nagano-ken (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/379,242

(22) Filed: Mar. 4, 2003

(30) Foreign Application Priority Data
Mar. 5, 2002 (JP) 2002-059581

(51) Int. Cl. G09G 3/36

(52) U.S. Cl. 345/102

(57) ABSTRACT

A brightness control device sufficiently reduces lateral stripes that are caused by brightness control and occur on a display screen of a display device. The brightness control device 3 controls brightness on the display screen 2a in a the display device 2 by controlling the duty ratio of the PWM signal to be output to the lighting device 4, and wherein the frequency of the PWM signal is controlled in response to the vertical synchronization frequency of an image signal inputted to the display device 2. Accordingly, the frequency of the brightness control signal is not an integral multiple of the vertical synchronization frequency of an image signal. Thus, the dimmer control stripes that appear on the display screen 2a and which are caused by the switching noise of the inverter occurring synchronously with the rise and fall of the PWM signal are avoided.

### BACKGROUND OF THE INVENTION

1. Field of the Invention

The present invention relates to a brightness control device that controls brightness of a display screen in a display device by controlling the duty ratio of a brightness control signal to be output to a lighting device, e.g. an inverter-type, and a monitor.

2. Description of the Related Art

In the following description, the term “monitor” will be used to describe a display device generically, and is intended to refer to all such display devices such as the typical CRT (cathode ray tube) display used for desktop computers, LCD (liquid crystal display) used in notebook computers, cell phones, etc., and OEL (organic electroluminescent) display used in handheld devices, etc. It is preferable that a monitor comprises a structure where the brightness of a display screen can be controlled appropriately (such as a dimmer control) in response to the brightness of operating environment. This improves sight recognition and reduces fatigue of the eyes that may result if viewed for long periods. In particular, a monitor used in a car navigation system will be viewed in a changing environment having large differences in brightness and darkness ranging from bright daylight to night, in which there is hardly any ambient light. Therefore, the brightness control of a display screen is indispensable. Typically, such brightness is controlled in response to turning a lamp in the automobile on or off, or brightness is controlled by detecting brightness of ambient light through a light receiving sensor.

Such a monitor 51 generally comprises a display device 52, a brightness control device 53 and a lighting device 4 as shown in FIG. 4.

In this case, the display device 52 separates and demodulates the brightness signal, the transportation color signal, and color burst-signal from the input image signal and reproduces each primary color signal of RGB (red, green, blue). Further, the display device 52 separates a synchronizing signal (a horizontal synchronizing signal and a vertical synchronizing signal) from an image signal and varies the brightness of each of the pixels of RGB comprising the display screen 52a in response to each primary color signal, while the display screen 52a is scanned in a horizontal direction and a vertical direction by the synchronizing signal in each period. Hence, a color image can be displayed on the display screen 52a.

The brightness control device 53 comprises a light receiving sensor 3a, a filter 3b and a control portion 53c. In this case, in the brightness control device 53, the light receiving sensor 3a detects the brightness of ambient light, and outputs a detecting signal S1 having a DC voltage. The filter 3b is set with a comparatively large time constant, removes a noise component (a high frequency component) included in the inputted detecting signal S1 and outputs a the detecting signal S2 of voltage level that corresponds to an average brightness. The control portion 53c generates ambient light data which represents the brightness of ambient light by performing A/D conversion of the input detecting signal S2 and produces a PWM (Pulse Width Modulation) signal Sc as a brightness control signal by processing this ambient light data. In this case, the control portion 53c changes the duty ratio of the PWM signal Sc that is set to a given specific frequency equal to or more than 100 Hz in response to the brightness of ambient light.

The lighting device 4 comprises an inverter 4a and a fluorescent lamp (back light) 4b. In this lighting device 4, the inverter 4a generates a driving signal Sd by repeating oscillation and non-oscillation of several tens kHz in response to the duty ratio of the input PWM signal Sc, as shown in FIG. 5. Further, the fluorescent lamp 4b flashes on and off since it is driven by this the driving signal Sd. In this case, the flashing period of the fluorescent lamp 4b, which is related to the frequency fc of the PWM signal Sc (period Tc) is set to larger than 100 Hz. Hence, the human eye will not sense the flashing of the fluorescent lamp 4b (flicker). Thus, brightness of the display screen 52a, which is lighted by illumination-light L from the fluorescent lamp 4b, is recognized as an averaged brightness corresponding to the duty ratio of the PWM signal Sc.

Therefore, in this monitor 51, the brightness control device 53 detects brightness of ambient light, based on the detecting signal S2 that is input through the filter 3b, and generates the PWM signal Sc, the duty ratio of which is in response to the brightness of ambient light. The duty ratio (the ratio of its oscillation period and its non-oscillation period) of the inverter 4a in the lighting device 4 varies thereby and the quantity of light of illumination light L emitted by the fluorescent lamp 4b varies automatically in response to brightness of ambient light. Therefore, in this monitor 51, brightness of the display screen 52a in the display device 52 lighted with illumination light L can be controlled automatically (automatic dimmer control) in response to the brightness of ambient light. In detail, during daylight when ambient light is bright, brightness on the display screen 52a in the display device 52 is increased by controlling the duty ratio of the PWM signal Sc to be large. Thus, as a result of increased brightness of image displayed on the display screen 52a in the display device 52, an image can be recognized well even in a bright environment. On the other hand, during the time from evening to night when ambient light decreases, brightness on the display screen 52a in the display device 52 is decreased by controlling the duty ratio of the PWM signal Sc to be small. Thus, as a result of decreased brightness of an image displayed on the display screen 52a in the display device 52, an image can be recognized without being too bright for the viewer.

However, this conventional brightness control device 53 and the monitor 51 have the following problems. Namely, in the brightness control device 53 and the monitor 51, the frequency fc of the PWM signal Sc is determined without considering the vertical synchronization frequency fv (frequency of the vertical synchronizing signal Sv) of an image signal input to the display device 52. Hence, as shown in FIG. 6, when the frequency fc of the PWM signal Sc (having period Tc) is an integral multiple (2 times as an example in this figure) of the vertical synchronization frequency fv (period Tv), the timing of each rise and fall of the PWM signal Sc is always located at the same position for each vertical scan (each field). In this case, switching noise occurs synchronously with this rise and fall of the PWM signal Sc since the inverter 4a is turned on and off synchronously with it. Hence, this switching noise always occurs similarly with every each vertical scan. Therefore, as shown in FIG. 7, lateral stripes (dimmer control stripes) ST caused by the switching noise being added with every vertical scan show up in a given location (fixed location) on a the display screen 52a. Hence, these raise a problem in that the display quality of the monitor 51 is deteriorated. This problem also occurs in a multi-monitor that is designed to display a normal image even if either of image signals of NTSC system (having a vertical synchronization frequency of 60 Hz) and PAL system (or SECAM system) (having a vertical synchronization frequency: 50 Hz) is input to it, for example.

### OBJECTS OF THE INVENTION

In order to overcome the above-mentioned problem, an object of the present invention is to provide a brightness control device that can reduce lateral stripes that are caused by brightness control and shown on a display device. Further, another object of the present invention is to provide a monitor that can reduce lateral stripes caused by brightness control and shown on a display device.

### SUMMARY OF THE INVENTION

In order to attain the above-mentioned objects, a brightness control device of the present invention controls the brightness of a display screen in a display device using a control unit that determines a duty ratio of a brightness control signal to be output to a lighting device by controlling a frequency of the brightness control signal in response to a vertical synchronization frequency of an image signal input to the display device.

Further, according to the brightness control device of the present invention, the frequency of the brightness control signal is (n+½) times the vertical synchronization frequency, where n is a natural number.

In another aspect of the present invention, the frequency of the brightness control signal is (6n±½) times the vertical synchronization frequency when the image signal conforms to one of a PAL system and SECAM system, and the frequency of the brightness control signal is (5n+½) times the vertical synchronization frequency when the image signal conforms to a NTSC system, where n is a natural number.

The present invention is also directed to a method for controlling the brightness of a display screen in a display device in accordance with the above features, and a monitor the employs the brightness control device having the above features.

### BRIEF DESCRIPTION OF THE DRAWINGS

FIG. 1 is a block diagram of the monitor 1 of the present invention.

FIG. 2 is a timing chart of the vertical synchronizing signal Sv and the PWM signal Sc.

FIG. 3 is a timing chart illustrating the timing of the rise and fall of the PWM signal Sc shifted in every period of the vertical synchronizing signal Sv.

FIG. 4 is a block diagram of the monitor 51.

FIG. 5 is a timing chart showing the relationship of the PWM signal Sc to the driving signal Sd in the monitor 51 and the monitor 1.

FIG. 6 is a timing chart showing the relationship of the vertical synchronizing signal Sv to the PWM signal Sc in the monitor 51.

FIG. 7 shows a display screen where dimmer control stripes occur on a the display screen 52a of the monitor 51.

FIG. 8 is a block diagram of the control portion 3c of the present invention.

### DESCRIPTION OF THE PREFERRED EMBODIMENTS

Preferred embodiments of the brightness control device and the monitor of the present invention will be explained as follows with reference to accompanying drawings.

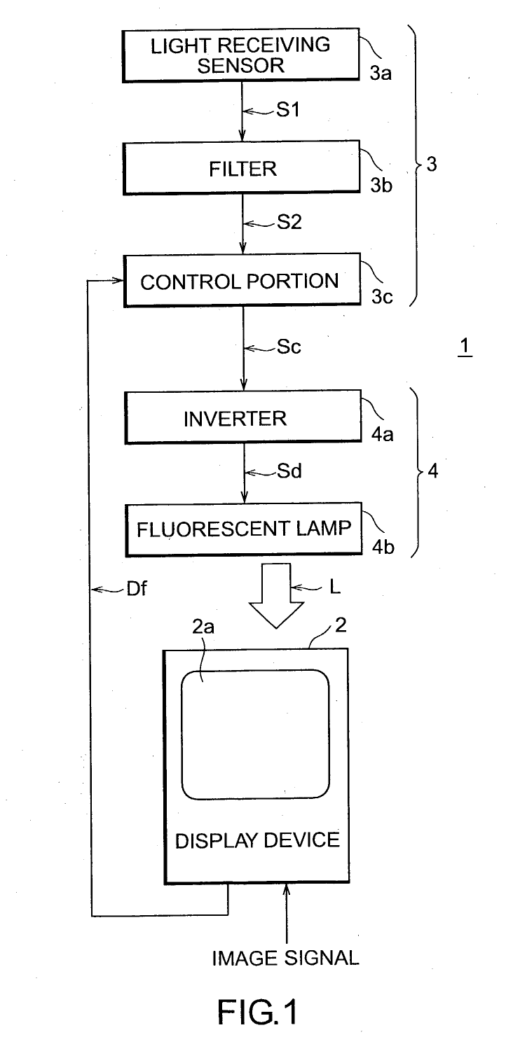

Firstly, a structure of the monitor 1 is described with reference to the FIG. 1. Here, structural elements that are the same as in the monitor 51 are referred with the same reference numerals, and such explanation is not repeated.

The monitor 1 is a multi-monitor that inputs either of image signals of PAL system (or SECAM system) or of NTSC system, to display such image. As shown in FIG. 1, it comprises the display device 2, a brightness control device 3 and the lighting device 4. In this case, the display device 2 consists of a liquid crystal display device, for example. The display device 2 reproduces each of the primary color signals corresponding to RGB by separating and demodulating a luminance signal, a carrier chrominance signal and a color burst-signal from an input image signal. Further, the display device 52 separates a synchronizing signal (a horizontal synchronizing signal and a vertical synchronizing signal) from an image signal and varies the brightness of each pixel of RGB that constitute the display screen (e.g., Liquid Crystal Display) 2a in response to each primary color signal, while the display screen 2a is scanned in a horizontal direction and a vertical direction in each period of each synchronizing signal. Further, the display device 2 detects the vertical synchronization frequency fv, and produces its frequency data Df.

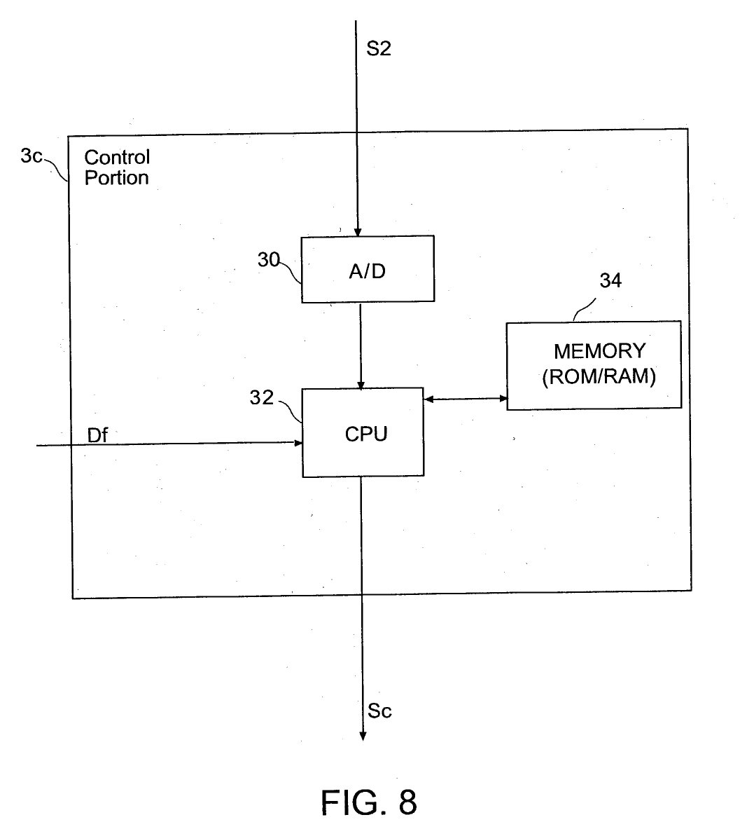

A brightness control device 3 comprises the light receiving sensor 3a, the filter 3b and a control portion 3c. The light receiving sensor 3a detects brightness of ambient light and output the detecting signal S1. In this case, the light receiving sensor 3a detects an irregular noise component (a high frequency component) that represents instantaneous changes in small amounts of ambient light that cannot be recognized by a human eye. The filter 3b removes this noise component included in the inputted detecting signal S1 and outputs the detecting signal S2. With reference to FIG. 8, the control portion 3c comprises an analog-to-digital converter 30, a CPU 32 and an internal memory (e.g. RAM and/or ROM) 34, for example. The analog-to-digital converter 30 converts the inputted detecting signal S2 into ambient light data representing brightness of ambient light with analog-to-digital transformation. The CPU 32 is operated in accordance with a program stored in the internal memory 34 and produces the PWM signal (the brightness control signal) Sc based on the frequency data Df generated by the display device 2 and the ambient light data. In this case, the CPU 32 produces the PWM signal Sc by utilizing an internal programmed timer that is counted by clock signals for CPU operation. Further, the CPU 32 determines the frequency fc of the PWM signal Sc by inputting the frequency of the vertical synchronization frequency fv specified by frequency data Df into the following expression (1) stored in the internal memory 34, when the PWM signal Sc is generated. Furthermore, CPU 32 determines the duty ratio of the PWM signal Sc based on ambient light data.

fc=(n±½)×fv

Here, n is a natural number, and the frequency fc of the PWM signal Sc is greater than 100 Hz according to the present embodiment. Thus, flicker can be reduced. Further, as will be explained hereafter, a particular example is chosen where (n+½) is used and n=2 in order to increase the frequency to more than 100 Hz.

The lighting device 4 comprises the inverter 4a and the fluorescent lamp 4b. The inverter 4a produces the driving signal Sd shown in FIG. 5 by repeating oscillation of several tens kHz and non-oscillation in response to the duty ratio of the inputted PWM signal Sc. The fluorescent lamp 4b is driven by the produced driving signal Sd and it flashes on and off as a result. Hence, it generates illumination light L irradiating onto the display device 2.

Next, the operation of the monitor 1 is explained. Here, an example where an image signal of NTSC system is inputted as an image signal will be explained.

In the monitor 1, the display device 2 displays an image on the display screen 2a based on an inputted image signal. At the same time, the display device 2 detects the frequency (the vertical synchronization frequency) fv of the vertical synchronizing signal Sv (separated from an inputted image signal) and produces frequency data Df thereby. In this case, frequency data Df having a value 60 is generated since the vertical synchronization frequency fv of an input image signal of the NTSC system is 60 Hz. Here, a period of the vertical synchronizing signal Sv is Tv.

In the brightness control device 3, the light receiving sensor 3a detects brightness of ambient light and generates the detecting signal S1, and the filter 3b removes the noise component included in the detecting signal S1 and outputs the detecting signal S2. Subsequently the control portion 3c produces ambient light data based on the detecting signal S2. Further, the control portion 3c determines the frequency fc of the PWM signal Sc by inputting frequency data Df into the expression (1). In this case, frequency fc of the PWM signal Sc is given by the following equation since the frequency data Df has the value 60:

fc=(2+½)×60=150

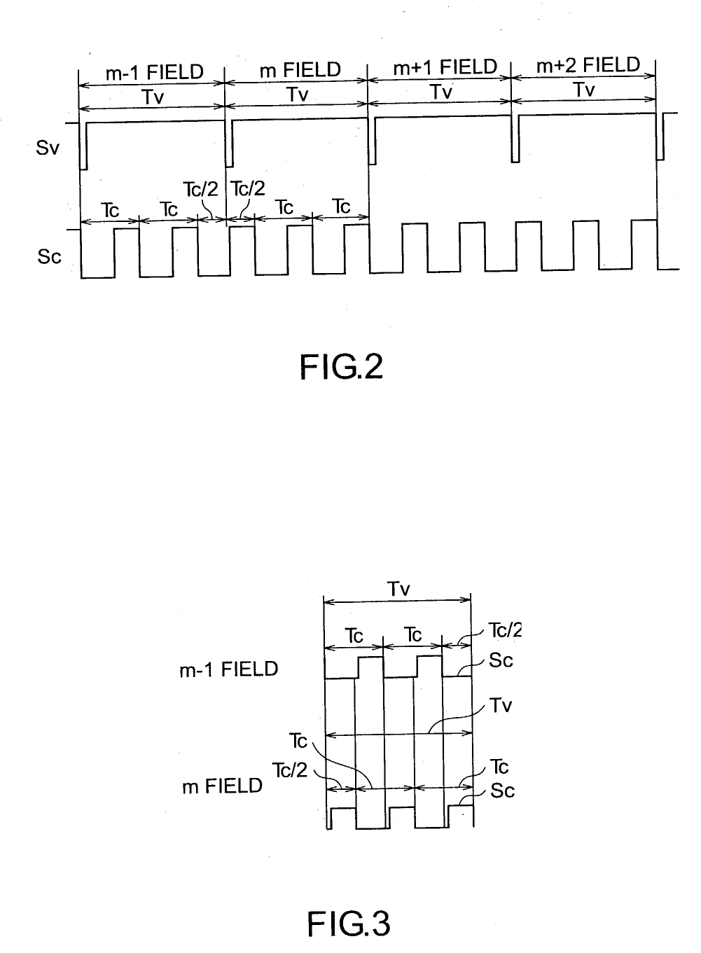

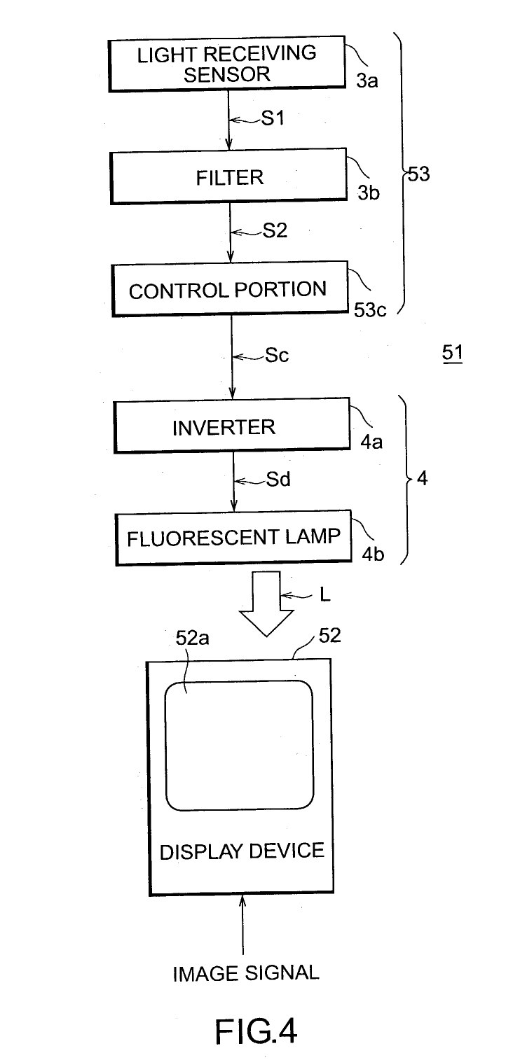

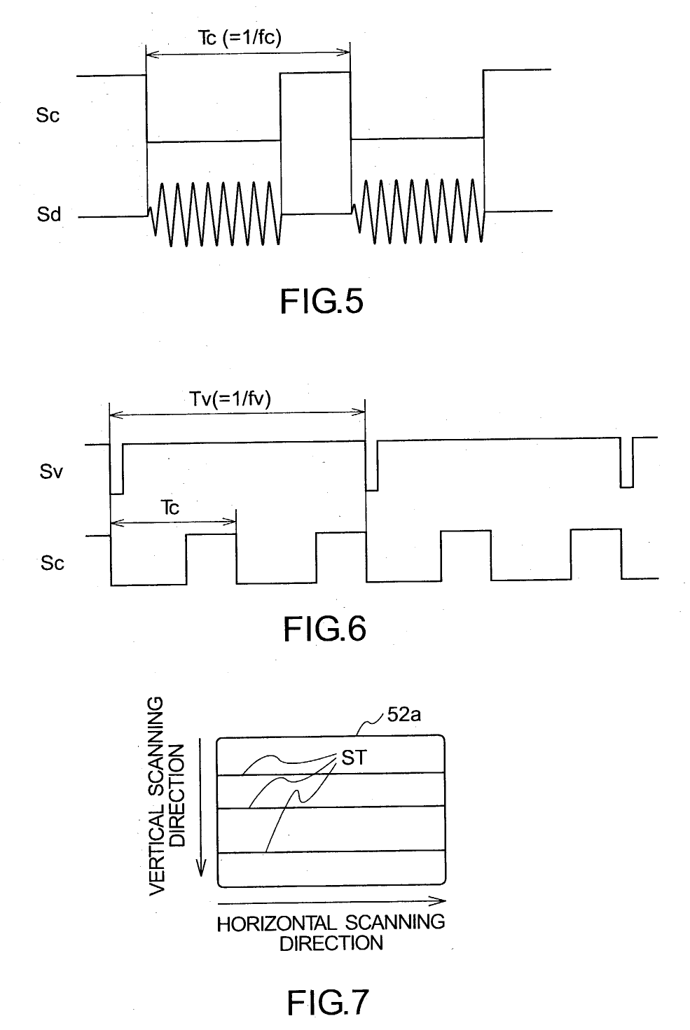

Further, the control portion 3c determines the duty ratio of the PWM signal Sc based on ambient light data, and the PWM signal Sc, shown in FIG. 2 is produced based on the determined frequency fc and duty ratio. Here, a period of the PWM signal Sc is Tc.

In this lighting device 4, the inverter 4a generates the driving signal Sd by repeating oscillation and non-oscillation of several tens kHz in response to the duty ratio of the inputted PWM signal Sc that has been produced by the brightness control device 3, and the fluorescent lamp 4b is driven thereby. In this case, the fluorescent lamp 4b flashes on and off, and lights up the display screen 2a with illumination light L of which the amount of light is determined by the duty ratio of the PWM signal Sc. As a result, the display screen 2a of a the display device 2 is lighted with illumination light L the brightness of which corresponds to the brightness of ambient light so that the brightness of the display is automatically controlled (automatic dimmer control).

In this case, in the monitor 1, the frequency fc of the PWM signal Sc is always set automatically (controlled to be switched) to be the middle value of an integral multiple of the vertical synchronization frequency fv included in an inputted image signal. Hence, as shown in FIG. 2, the timing of the rise and fall of the PWM signal Sc is always shifted by ½ of period Tc for every vertical scan (field). In other words, the PWM signal Sc is always most asynchronous with respect to the vertical synchronizing signal Sv to a maximum extent. As a result, as shown in FIG. 3, the rise and fall of the PWM signal Sc do not overlap with each other in every field. Hence, the present invention avoids the situation where switching noise occurs at the time when the inverter 4a moves to on and off operations synchronously with the rise (or fall) and fall (or rise) of the PWM signal Sc at the same timing in every vertical scan. Therefore, according to the monitor 1, even if an image signal having any kind of vertical synchronization frequency fv is inputted, lateral stripes (dimmer control stripes) ST occurring on the display screen 2a caused by switching noise, can be sufficiently reduced. Further, even if the frequency of the PWM signal Sc fluctuates to some extent, caused by temperature variations in electronic components, for example, the frequency of the PWM signal Sc can be asynchronous with respect the vertical synchronizing signal Sv. Hence, lateral stripes occurring on the display screen 2a caused by switching noise can be significantly reduced.

Further, the present invention is not limited to the above-mentioned embodiment. For example, according to the above embodiment of the present invention, the case in which the value (½) is added to n under the above-mentioned expression (1) for determining frequency fc of the PWM signal Sc was explained. In a different example of the present invention, the value (½) is subtracted from n when the frequency fc of the PWM signal Sc becomes a high frequency to avoid flickering by large numbers of the value n.

Further, the present invention can be applied to a monitor wherein the image signal that is input has the vertical synchronization frequency fv of the vertical synchronizing signal Sv in the inputted image is fixed to one type (namely, PAL system (SECAM system) or NTSC system). Here, above-mentioned lateral stripes (dimmer control stripes) occurring on the display screen can be significantly reduced even in this single image-type monitor.

In this case, the frequency fc of the PWM signal Sc produced by the brightness control device is pre-set to be (n+½) times the vertical synchronization frequency fv in a image signal inputted to the display device.

Further, according to the above embodiment of the present invention, the single above-mentioned expression (1) is used for determining the frequency fc of the PWM signal Sc. As an alternative, a plurality of expressions for determining frequency fc of the PWM signal Sc can be stored in advance in memory 34, and then one expression is selected by the control program to calculate the frequency fc in response to the vertical synchronization frequency fv of an inputted image signal. As an example, in the multi-monitor either of image signals for PAL system (or, SECAM system) and NTSC system can be inputted. Here, basic configuration of this multi-monitor is the same of the monitor 1 and the same elements are referred as the same reference numbers. Further, the vertical synchronization frequency fvP of an image signal of PAL system and SECAM system is 50 Hz, the vertical synchronization frequency fvN of an image signal of NTSC system is 60 Hz. Hence, in this multi-monitor, the following expression where n is natural numbers, is stored beforehand in the internal memory 34 of the control portion 3c.

fcN=(5n±½)×fvN (2)

fcP=(6n±½)×fvP (3)

In this multi-monitor, the CPU 32 of the control portion 3c selects, based on the frequency data Df, either of the above expression (2) or the above expression (3) that are pre-stored in the memory 34. The frequency fc (fcN, fcP) of the PWM signal Sc is determined by introducing the frequency (fvN, fvP) of the vertical synchronization frequency fv, specified by the frequency data Df, into the selected expression. The CPU 32 calculates the frequency fcN of the PWM signal Sc based on the expression (2) when the frequency data Df is the value of 60 (namely, when an image signal of NTSC system is inputted). On the other hand, it calculates the frequency fcP of the PWM signal Sc based on the expression (3) when the frequency data Df is the value of 50 (namely, when an image signal of PAL or SECAM system is inputted). According to this calculation formula, in case of n=1, the frequency fcN of the PWM signal Sc is 270 Hz (or, 330 Hz) when the frequency data Df is the value 60, and the frequency fcP of the PWM signal Sc is 275 Hz (or 325 Hz) when the frequency data Df is the value 50. Thus, the difference between the frequencies fcN and fcP can be always maintained to only 5 Hz. Therefore, the control program can be simply modified from the first example to include a step of selecting one equation or the other to generate the frequencies fcN and fcP.

Further, the CPU 32 of the control portion 3c determines the duty ratio of the PWM signal Sc for each of the frequencies fcN and fcP based on ambient light data. Thus, the duty ratios of the PWM signal Sc for the frequencies fcN and fcP are the same under the situation when brightness of ambient light is the same. In this case, as shown in FIG. 5, when on/off operation of the inverter 4a is controlled with the PWM signal Sc, the waveform does not rise sharply relative to the transient response of the inverter 4a. However, in this multi-monitor, the duty ratios of the PWM signal Sc for the frequencies fcN and fcP are the same as each other and the difference between the frequencies fcN and fcP can be maintained within 5 Hz. Therefore, according to this multi-monitor, the brightness differences in the display screen 2a between modes for NTSC system and PAL system (SECAM system) can be minimized to the extent that they can be ignored. Hence, the quality of dimmer control as a multi monitor can be improved.

Further, according to the above-described embodiment of the present invention, the multi-monitor displaying an image signal of NTSC system/PAL system (SECAM system) was used as an example. However, the present invention can apply not only to the case when the vertical synchronization frequency fv is 50 Hz or 60 Hz, but to the case for the multi-monitor displaying an image signal of any other kind of the vertical synchronization frequency fv. Further, according to the embodiment of the present invention, an example case included a luminance signal, a carrier chrominance signal, a color burst signal and a synchronizing signal that were integrated as the inputted image signal. On the other hand, the present invention can also be applied to a monitor into which an image signal is inputted, for example, where a synchronizing signal is separated from other signals. Furthermore, an oscillator including PLL or DDS (Direct Digital Synthesizer) for producing the PWM signal Sc is provided so that the control portion 3c can control to switch the oscillation frequency of such oscillator.

According to the brightness control device of the present invention, a frequency of a brightness control signal is controlled to be switched in response to a vertical synchronization frequency in an image signal inputted to a the display device. This avoids the situation where a frequency of a brightness control signal becomes an integral multiple of a vertical synchronization frequency of an image signal. Therefore, the timing of the rise and fall of a brightness control signal is shifted in every vertical scan. This prohibits the situation where a switching noise of an inverter, occurring synchronously with the rise and fall of the brightness control signal occurs at the same timing in every vertical scan. As a result, even if an image signal of various kinds of vertical synchronization frequency is inputted, the lateral stripe caused by the above-mentioned switching noise on a display screen (dimmer control stripe) can be sufficiently reduced.

In addition, according to the brightness control device of the present invention, the frequency of the brightness control signal is controlled to be switched to (n+½) times the vertical synchronization frequency of an inputted image signal. Thus, the frequency of brightness control signal is kept asynchronous with respect to the vertical synchronization frequency. Therefore, even if electronic components are fluctuate due to changes in temperature, for example, the frequency of the brightness control signal remains asynchronous with respect to the vertical synchronization frequency. Hence, the lateral stripes caused by the switching noise on the display screen, can be reduced further.

Furthermore, according to the brightness control device of the present invention, the frequency of the brightness control signal is controlled to be (6n±½) times the vertical synchronization frequency when an image signal belongs to PAL system or SECAM system. The frequency of the brightness control signal is controlled to be (5n±½) times the vertical synchronization frequency when an image signal belongs to NTSC system. The difference of the frequency of the brightness control signal between PAL system (SECAM system) and NTSC system is maintained at only 5 Hz. Therefore, as a result that each frequency of brightness control signal for above system is close to each other, the modifications required at the time changing frequency are minimized.

According to the monitor of the present invention, the situation where the frequency of the brightness control signal becomes an integral multiple of the vertical synchronization frequency of an image signal is avoided since the above-described brightness control device is provided in the monitor. Hence, the timing of the rise and fall of the brightness control signal is shifted in every vertical scan. Thus, the lateral stripes (dimmer control stripes) caused by switching noise on the display screen, can be reduced sufficiently. Therefore, the monitor that provides high quality brightness control to the display screen is achieved.

What is claimed is:

1. A brightness control device that controls the brightness of a display screen in a display device comprising:
a control unit that determines a duty ratio of a brightness control signal to be output to a lighting device by controlling a frequency of the brightness control signal in response to a vertical synchronization frequency of an image signal input to the display device.

2. A brightness control device according to claim 1, wherein the frequency of the brightness control signal is (n+½) times the vertical synchronization frequency, where n is a natural number.

3. A brightness control device according to claim 1, wherein;
the frequency of the brightness control signal is (6n±½) times the vertical synchronization frequency when the image signal conforms to one of a PAL system and SECAM system, and
the frequency of the brightness control signal is (5n±½) times the vertical synchronization frequency when the image signal conforms to a NTSC system, where n is a natural number.

4. A monitor comprising:
a display device that displays image signals having one vertical synchronization frequency and image signals having a different vertical synchronization frequency;
a lighting device that lights a display screen of the display device; and
a brightness control device that controls the brightness of the display screen in the display device comprising:
a control unit that determines a duty ratio of a brightness control signal to be output to the lighting device by controlling a frequency of the brightness control signal in response to a vertical synchronization frequency of an image signal input to the display device.

5. A monitor according to claim 4, wherein the frequency of the brightness control signal is (n+½) times the vertical synchronization frequency, where n is a natural number.

6. A monitor according to claim 4, wherein;
the frequency of the brightness control signal is (6n±½) times the vertical synchronization frequency when the image signal conforms to one of a PAL system and SECAM system, and
the frequency of the brightness control signal is (5n±½) times the vertical synchronization frequency when the image signal conforms to a NTSC system, where n is a natural number.

7. A method of controlling the brightness of a display screen in a display device comprising:
determining a duty ratio of a brightness control signal to be output to a lighting device by controlling a frequency of the brightness control signal in response to a vertical synchronization frequency of an image signal input to the display device.

8. A method of controlling the brightness of a display screen in a display device according to claim 7, wherein the frequency of the brightness control signal is (n+½) times the vertical synchronization frequency, where n is a natural number.

9. A method of controlling the brightness of a display screen in a display device according to claim 7, wherein;
the frequency of the brightness control signal is (6n±½) times the vertical synchronization frequency when the image signal conforms to one of a PAL system and SECAM system, and
the frequency of the brightness control signal is (5n±½) times the vertical synchronization frequency when the image signal conforms to a NTSC system, where n is a natural number.
